(19) United States
(12) Patent Application Publication
(10) Pub. No.: US 2004/0123929 A1
(43) Pub. Date: Jul. 1, 2004

(54) Tyre for aircraft

(76) Inventor: Baolu Han, Shandong (CN)

Correspondence Address: Rogers Tower, Suite 1500, 1301 Riverplace Boulevard, Jacksonville, FL, 32207, US

(21) Appl. No.: 10/472,783

(22) PCT Filed: Mar. 28, 2002
(86) PCT No.: PCT/CN02/00212

(30) Foreign Application Priority Data
Mar. 29, 2001 (CN) 01236180.1

(51) Int. Cl. B60C 13/02

(52) U.S. Cl. 152/523

(57) ABSTRACT

This practical new style is a kind of airplane tire. It designs at least two windears sticking out of the both side of the tirebody. One side of the windear is a concave structure and two sides of which have the same direction. Using this practical new style, the airplane tires are enable to rotate before landing of the plane. This helps the rotating speed of the wheels be equal to or faster the relative movement speed between the airplane and the runway, that makes the wheel speed be consistent with the touchdown speed, eliminate the speed differential between the wheels and the runway, change the sliding drag to the rotating drag so that it can reduce the tearing of the tires and prolong the service life of the wheels.

This practical new style is one kind of airplane tire. When airplane is landing, its wheels are still in almost static attitude while the plane itself maintains high-speed movement. For this reason, when the plane is approaching the runway and ready to land (before touchdown), there will be a kind of high-speed relative movement between the plane and the runway. At the moment of the touchdown, the almost static wheels will accelerate in sudden in order to consist with the relative movement between the plane and the runway, and produce a great friction force with the runway. Meanwhile there will appear dark smoke and black trace on the runway. That is to say the tires are greatly torn. This kind of tearing will not only shorten the service life of tires, if it becomes severe, it may result to break of tire and the accident of airplane.

This practical new-style aims at design a kind of airplane tire, which can have lighter tearing while landing, enabling to prolong the service life and reduce the hidden danger of accident as well.

This practical new style is designed to add at least two windears sticking out of the both sides of the update airplane tirebody. One side of the windear is designed in concave structure, both side of which consist with each other.

Using this practical windears, the wheel is able to rotate before the plane landing, so that the rotational speed of wheels will be equal to or higher than the relative movement speed between the plane and the runway, i.e., the speed of wheels consists with speed of touchdown, eliminate the speed differential between wheels and the runway, changes the sliding drag into rotating drag, so it can greatly reduce the tearing and prolong the service life of the wheels.

Each windear is designed of pyramid or other shapes. When it is a pyramid, the exterior surface of each windear is a pyramid, the angle of the touch point in the surface where the tirebody and the pyramid meet is located on the widest part in the tirebody axis direction. The external angle of this practical new-style may locate on the edge of tirebody when the compress capacity reaches highest point, and the internal angle direct to the center axis of the tire body. In addition, the distance between the internal angle and the external angle and the touch point angle should be larger than the distance between the external angle and the touch point angle.

The concave structure of each windear for this practical new style may be the open cavity of the side where the internal and the external angle are. The line between each internal angle and the external angle is on the radial line of the tirebody.

The implement example of this practical new style will be explained in detail in the following figures.

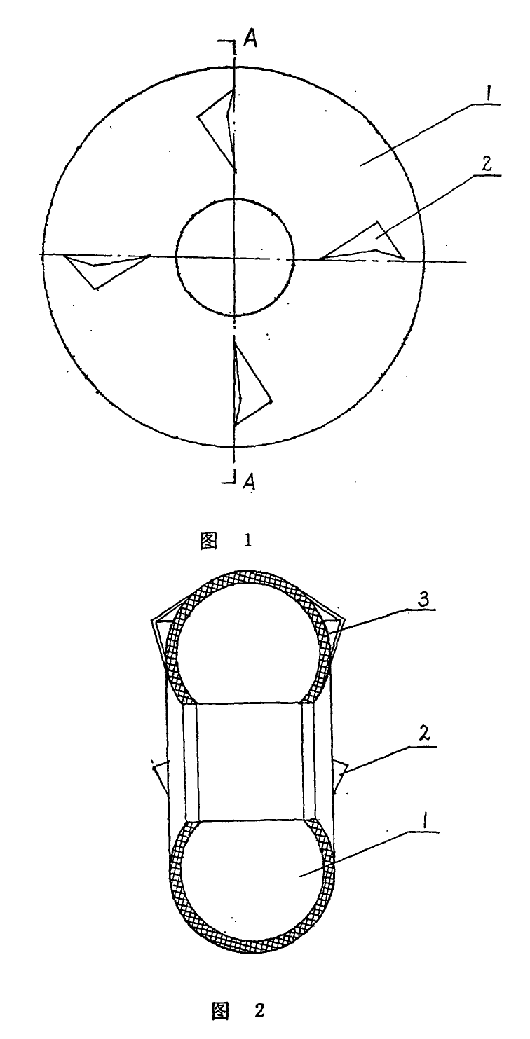

FIG. 1 is the main view of the implement example for this practical new style.

FIG. 2 is the side view of the implement example. Including: 1-tirebody, 2-windear, 3-concave structure.

As the figure shows, this implement example contains of the tirebody 1. On both sides of which there are six windear sticking out. Each windear 2 is a pyramid, connected with the tirebody 1 forming the internal angle, which is on the surface direct to the center axis of the tirebody 1. The external angle is located on the edge of the tirebody when the compress reaches the highest point. The other angle is on the widest part of axis of the tirebody 1. In addition, there is the concave structure in each windear 2, formed up of the cavity of the internal and the external angle of the side, and the line connecting the internal and the external angle is along the radial line of the tirebody 1.

I claim:

1. The feature of one kind of airplane tire, including the tirebody (1) is there are at least two windears (2) sticking out of the both dies of the tirebody (1). On one side of the windear (2) is the concave structure (3), which consists with both the windear on both sides of the tirebody in direction.

2. According to the right demands 1 the feature of the above written airplane tire is: the external surface is each windear is a pyramid. The angle of the pyramid and the tirebody on the surface is on the widest part of the tirebody axis.

3. According to the right demand 1 or 2, the feature of the above written airplane tire is: the external angle of each windear (2) is on the edge of the tirebody when compress capacity reaches to the highest point.

4. According to the right demand 1 or 2, the feature of the written airplane tire is: the internal angle of the windear (2) direct to the center axis of the tirebody (1).

5. According to the right demand 1 or 2, the feature of the above written airplane is: the distance between the internal angle of the windear (2) to the external angle or the touch point is larger than the distance between the external angle and the angle at the touch point.

6. According to the right demand 1 or 2, the feature of the above written airplane tire is: the concave structure (3) of the windear is the open cavity of the side where the interior and the external angle are.

7. According to the right demand 6, the feature of the above written airplane tire is: the line connected to the internal and external angle of windear is on the radial line of the tirebody (1).
